(19) United States
(12) Patent Application Publication
(10) Pub. No.: US 2026/0303527 A1
(43) Pub. Date: Oct. 1, 2026

(54) TOPOLOGY RECONFIGURATION METHOD AND DEVICE FOR ONOC

(71) Applicant: Beijing University of Posts and Telecommunications, Beijing (CN)

(72) Inventors: Qiuyan YAO, Beijing (CN); Hui YANG, Beijing (CN); Junji FENG, Beijing (CN); Daqing MENG, Beijing (CN); Jie ZHANG, Beijing (CN)

(73) Assignee: Beijing University of Posts and Telecommunications, Beijing (CN)

(21) Appl. No.: 19/270,659

(22) Filed: Jul. 16, 2025

(30) Foreign Application Priority Data
Apr. 1, 2025 (CN) 202510402436.1

(51) Int. Cl. H04L 45/745

(52) U.S. Cl. CPC H04L 45/745

(57) ABSTRACT

A topology reconfiguration method for an Optical Network-on-Chip (ONoC) includes: receiving task information; selecting a target topology based on the task information; determining target nodes and target links that make up the target topology; generating a global routing table based on the target nodes and the target links; and issuing the global routing table to the target nodes to enable the ONoC to forward task data according to the global routing table.

### CROSS-REFERENCE TO RELATED APPLICATIONS

This application claims priority to Chinese Patent Application No. 202510402436.1, filed on Apr. 1, 2025, the content of which is incorporated herein by reference in its entirety.

### TECHNICAL FIELD

The present disclosure relates to communication technologies, and in particularly, to a topology reconfiguration method and device for an Optical Network-on-Chip (ONoC).

### BACKGROUND

Optical network chips have significant advantages such as high bandwidths, low latencies, and low power consumptions, which can effectively connect various processing cores and achieve transmissions with a higher performance. With an increasing demand for a high communication bandwidth and a high-performance computing, ONoCs using the wavelength division multiplexing technology may improve the communication bandwidth effectively by multiplexing multiple optical signals of different wavelengths into a single waveguide for data transmissions.

In ONoCs, with continuous emergence of various complex tasks, configurations of network nodes and links may need to be adjusted constantly to adapt to communication loads and data traffic of the tasks. Traditional static network architectures are no longer able to meet efficient processing requirements. However, reconfigurable topology technologies now face problems such as a limited flexibility in topology switching and an insufficient ability to perceive a task load.

### SUMMARY

In view of the above, examples of the present disclosure provide a topology reconfiguration method and device for an ONoC to solve the problems of a task-based topology reconstruction.

Examples of the present disclosure provide a topology reconfiguration method for an ONoC, which includes: receiving task information; selecting a target topology based on the task information; determining target nodes and target links that make up the target topology; generating a global routing table based on the target nodes and the target links; and issuing the global routing table to the targets nodes to enable the ONoC forward task data according to the global routing table.

In some examples of the present disclosure, the task information may include: a priority of a task, a data volume of the task, and an execution time of the task.

In some examples of the present disclosure, the selecting a target topology based on the task information may include: determining a type of the task based on the priority of the task, the data volume of the task, and the execution time of the task; and selecting the target topology based on the type of the task.

In some examples of the present disclosure, the determining a type of the task based on the priority of the task, the data volume of the task, and the execution time of the task may include: quantifying the priority of the task to obtain a priority score; quantifying the data volume of the task to obtain a data volume score; quantifying the execution time of the task to obtain an execution time score; determining a comprehensive score of the task based on the priority score, the data volume score, and the execution time score; and determining the type of the task based on the comprehensive score according to a mapping relationship between comprehensive scores and types of the tasks.

In some examples of the present disclosure, the determining target nodes and target links that make up the target topology may include: obtaining status of nodes in the ONoC; obtaining status of links in the ONoC; and determining the target nodes and the target links that make up the target topology based on the target topology, the status of the nodes and the status of the links.

In some examples of the present disclosure, the obtaining status of nodes in the ONoC may include: obtaining computing resources, storage resources, and energy consumptions of the nodes; and for each node of the nodes, determining whether the node is in an available status or in an unavailable status based on the computing resources, the storage resources, the energy consumptions of the nodes, and pre-set node availability conditions.

In some examples of the present disclosure, the obtaining status of links in the ONoC may include: detecting loads and physical connectivity of the links; and for each link of the links, determining whether the link is in an available status or in an unavailable status based on the loads and the physical connectivity of the links, and pre-set link availability conditions.

In some examples of the present disclosure, the determining the target nodes and the target links that make up the target topology based on the target topology, the status of the nodes and the status of the links may include: determining a set of available nodes based on the status of the nodes; determining a topology template corresponding to the target topology; determining a candidate node set from the available nodes based on the topology template; and determining the target nodes and the target links from the candidate node set based on the status of the links.

In some examples of the present disclosure, the determining a set of available nodes based on the status of the nodes comprises: obtaining information on at least one of computing resources, storage resources, and energy consumptions of the nodes as status information of the nodes; selecting nodes with basic working capabilities based on the status information of the nodes and preset node availability conditions to form a set of available nodes; wherein, the preset node availability conditions comprise at least one of a computing resource threshold, a storage resource threshold and an energy consumption limit.

In some examples of the present disclosure, the target template comprises topology features and node position constraints; and the determining a candidate node set from the available nodes based on the topology template comprises: filtering each node in the set of the available nodes to find nodes that meet the topology features and the node position constraints to form a candidate node set.

In some examples of the present disclosure, the determining the target nodes and the target links from the candidate node set based on the status of the links comprises: taking the nodes in the candidate node set as the target nodes; determining links that should be formed according to the topology features of the topology template in the candidate node set as candidate target links; checking the status of the candidate target links; for each candidate target link, in response to determining that the candidate target link is in an available status, taking the candidate target link as the target link.

In some examples of the present disclosure, the target template further comprises reserved redundant node positions; the determining a candidate node set from the available nodes based on the topology template further comprises: scoring and sorting nodes that match the reserved redundant node positions in the candidate node set based on the status information of the nodes that match the reserved redundant node positions; and the determining the target nodes and the target links from the candidate node set based on the status of the links further comprises: in response to determining that the candidate target link is in an unavailable status, replacing the target nodes connecting the target link with suboptimal redundant nodes, and return to the step of checking the status of the candidate target links until it is determined that all target links are available.

In some examples of the present disclosure, the method may further include: in response to determining that the target nodes that make up the target topology cannot be determined, selecting an alternative topology based on the type of the task; and determine the target nodes and the target links that make up the alternative topology based on the alternative topology.

In some examples of the present disclosure, the method may further include: after determining the target nodes and the target links that make up the target topology, sending an activating signal to the target nodes; sending an inactivating signal to nodes that do not make up the target topology; and sending a conducting signal to the target links.

In some examples of the present disclosure, the method may further include: after sending a conducting signal to the target links, sending a detecting signal to the target nodes; in response to determining that no feedback signal is received from the target nodes or a transmission quality is evaluated to be lower than a preset quality threshold based on a feedback signal, optimizing status of the target links by adjusting parameters of micro-ring resonators of the target nodes.

In some examples of the present disclosure, the method may further include: initializing a network topology of the ONoC to the torus topology; after determining the target topology, switching the torus topology to the target topology.

Based on the same inventive concept, the present disclosure further provides an electronic device comprising a memory, a processor, and a computer program stored on the memory and executable by the processor, wherein the processor executes the computer program to implement the method described above.

Based on the same inventive concept, the present disclosure further provides a non-transitory computer-readable storage medium storing computer instructions, wherein the computer instructions are used to cause a computer to execute the method described above.

It can be seen from the above description that the topology reconfiguration method and device for an ONoC provided in examples of the present disclosure may select a target topology based on task information, determine target nodes and target links that make up the target topology, generate a global routing table based on the target topology, and issue the global routing table to the target nodes to enable the ONoC to forward task data according to the global routing table. This application can be adapted to diverse task requirements to improve a flexibility and an adaptability of the ONoC, and fully develop the performance and potential of the ONoC.

### BRIEF DESCRIPTION OF THE DRAWINGS

To illustrate technical solutions of the present disclosure or the prior art more clearly, drawings used in examples or the prior art will be briefly introduced. Obviously, the drawings in the following description are only some examples of the present disclosure. For those of ordinary skill in the art, other drawings may be obtained based on these drawings without creative effort.

FIG. 1 is a flowchart of a topology reconfiguration method for an ONoC according to an example of the present disclosure.

FIG. 2A to 2E illustrate five types of topologies according to examples of the present disclosure.

FIG. 3 is a schematic diagram of a structure of a micro-ring resonator according to an example of the present disclosure.

FIG. 4 is a schematic diagram of a connection structure of an ONoC according to some examples of the present disclosure.

FIG. 5 is a flowchart of a task driven topology configuration method according to an example of the present disclosure.

FIG. 6 is a structural diagram of a topology reconfiguration device according to an example of the present disclosure.

FIG. 7 is a hardware structure diagram of an electronic device according to an example of the present disclosure.

### DETAILED DESCRIPTION OF THE EMBODIMENTS

To make the objectives, technical solutions, and advantages of the present disclosure clearer, the following further describes the present disclosure in detail with reference to specific examples and accompanying drawings.

It should be noted that, unless otherwise defined, technical terms or scientific terms used in the examples of the present disclosure shall have the ordinary meanings understood by persons skilled in the art. The terms “first,” “second,” and similar terms used in the examples of the present disclosure do not denote any order, quantity, or importance, but are merely used to distinguish different components. The terms “comprising” or “including” and similar terms mean that elements or items preceding the term encompass elements or items listed after the term and their equivalents, but do not exclude other elements or items. The terms “connected” or “coupled” and similar terms are not limited to physical or mechanical connections, but may include electrical connections, whether direct or indirect. Terms such as “upper,” “lower,” “left,” and “right” are used only to indicate relative positional relationships. When the absolute position of the described object changes, the relative positional relationship may also change accordingly.

For clarity of the description, before describing specific technical solutions of the present disclosure, it is necessary to explain some terms involved in the present disclosure at first.

An optical Network-on-Chip (ONoC) may refer to a multi-core processor chip interconnect technology that uses photons to replace electronic signals for data transmissions, aiming to break through bottlenecks of traditional electrical interconnects in bandwidths, latencies, and power consumptions.

A torus topology (also known as k-ary n-cube topology) may refer to a multi-dimensional ring network. In the torus topology, each node may be connected to adjacent nodes through bidirectional channels and forms a closed loop. The advantage of the torus topology lies in its regular physical layout that can match chip packaging limitations. The torus topology may have a high path diversity, and may support a load balancing and bidirectional signal transmissions. Compared to the mesh topology, the torus topology may reduce network diameters and hops of data packets through closed loops. The limitation of the torus topology may be that the number of hops is still higher than that of logarithmic networks, which may increase latencies and pin costs.

The technical solution of the present application will be further explained in detail through specific examples.

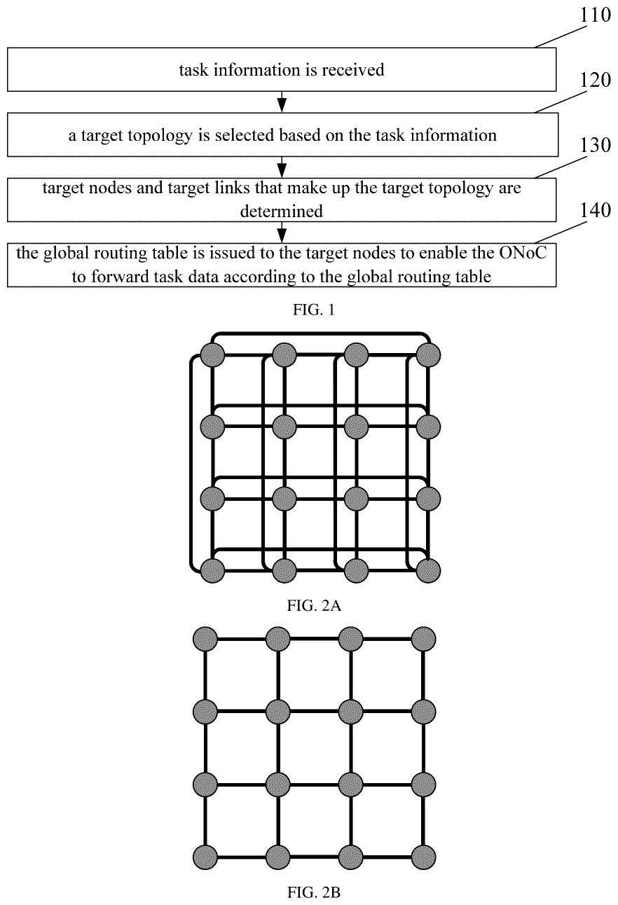

FIG. 1 is a flowchart of a topology reconfiguration method for an ONoC according to an example of the present disclosure. As shown in FIG. 1, the topology reconfiguration method for an ONoC may include the following steps.

In block 110, task information is received.

In some examples of the present disclosure, the ONoC may receive task information through a receiving interface. Moreover, the ONoC may also receive task data through the receiving interface. Further, the ONoC may also transmit and process the task data.

It can be understood that the ONoC can handle different types of tasks. In some examples of the present disclosure, the types of the tasks may include: tasks with high reliabilities and high fault tolerance requirements, tasks with large-scale parallel computing requirements, tasks with low frequencies, small data volumes and low real-time requirements, tasks with high real-time requirements, tasks with hierarchical structures and centralized resource managements, and etc.

In some examples of the present disclosure, the task information may include: at least one of a priority of the task, a data volume of the task and an execution time of the task. Among them, the execution time of the task may include time constraints of the task, such as a length of the execution time and an updating frequency of the data. Task parameters can be specific parameters of various tasks, such as control instructions of control tasks, calculation parameters of calculation tasks, monitoring parameters of monitoring tasks, and so on. In addition, different types of tasks can correspond to different priorities based on their impact on system securities, timeliness, and resource consumptions. For example, a task with a highest reliability and a highest fault tolerance requirement may have a highest priority; a task with a high real-time requirement may have a second highest priority; a task with a large-scale parallel computing requirement may have a medium priority; a task with a hierarchical structure and requiring a centralized resource management may have a medium low priority; and a task with a low frequency, a small data volume, and a low real-time requirement may have a lowest priority. It can be understood that when there is a resource conflict, lower priority tasks can be downgraded or delayed in execution to ensure the stability of higher priority tasks.

In block 120, a target topology is selected based on the task information.

In some examples of the present disclosure, after receiving the task information, the target topology suitable for executing the task may be selected from multiple candidate topologies by analyzing the task information. Specifically, the multiple candidate topologies may include: the torus topology, the mesh topology, the ring topology, the star topology and the tree topology.

Specifically, the selection of target topology based on the task information may include: determining a type of task based on the priority of the task, the data volume of the task, and the execution time of the task. Further, a target topology may be selected based on the type of the task.

In some examples of the present disclosure, by parsing the task information, parameters such as the priority of the task, the data volume of the task, and the execution time of the task may be obtained firstly. Then, based on the priority of the task, the data volume of the task, and the execution time of the task, a comprehensive evaluation of the resources required to execute the task may be conducted to determine the type of task. For example, data volume of environmental monitoring tasks may be relatively small, with only a few tens of bytes of data transmitted each time, and the transmission frequency is relatively low. Therefore, the bandwidth requirements of these tasks are low. Moreover, since the nodes mainly perform data forwarding without complex calculations, low memory usages are required. Further, the energy consumption of the entire task is mainly concentrated on sensor data collections and short distance transmissions, therefore, an overall demand on energy consumptions is relatively small. According to examples of the present disclosure, after determining the type of the task, the target topology may be selected based on the type of the task.

In some examples of the present disclosure, the method of determining the type of the task based on the priority of the task, the data volume of the task, and the execution time of the task may include the following steps.

Firstly, the priority of the task may be quantified to obtain a priority score of the task.

In some examples, the priority of the task may include the following 5 levels: Level 1 (highest): task interruptions can cause system crashes. Level 2: a real-time requirement is less than or equal to 10 ms. Level 3: allow a 100 ms to 1s delay. Level 4: delay tolerance of 1 to 10 seconds. Level 5 (lowest): non-real-time tasks. Further, the five task priorities mentioned above may be quantified and converted into numerical values in a [0.2, 1.0] interval to ensure high-level priorities dominate in weighted calculations. These numerical values may refer to priority scores of the tasks in examples of the present disclosure. Table 1 shows a specific example of a mapping relationship between the priorities of the tasks and the priority scores in the [0.2, 1.0] range.

TABLE 1

| Priority of task | Level 1 | Level 2 | Level 3 | Level 4 | Level 5 |
|---|---|---|---|---|---|
| priority score of task P | 1 | 0.8 | 0.6 | 0.4 | 0.2 |

It should be noted that the settings and specific quantification method of the priority of the task illustrated above are only examples. Other methods can be used in examples to quantify the priority of the task into a priority score of the task P.

Secondly, the data volume of the task may be quantified to obtain a data volume score of the task.

In some examples, the data volume can be divided into the following three levels based on a pre-set data volume threshold: a small data volume level: less than 1 KB/session (such as tens of bytes for environmental monitoring); a medium data volume level: 1 KB to 10 MB/session (such as image preprocessing data) and a large data volume level: greater than 10 MB/session (such as parallel computing datasets). Furthermore, the three levels of the data volume mentioned above may be quantified and converted into numerical values in a [0.3, 1.0] interval to ensure that the data volume level with larger data volume dominates in the weighted calculation. These numerical values may refer to data volume scores of the tasks in examples of the present disclosure. Table 2 shows a specific example of a mapping relationship between the data volume levels of the tasks and the data volume scores in the [0.3, 1.0] interval.

TABLE 2

| | Large data | Medium data | Small data |
|---|---|---|---|
| Data volume level | volume level | volume level | volume level |
| data volume score D | 1 | 0.6 | 0.3 |

It should be noted that the settings and specific quantification method of the data volume of the task illustrated above are only examples. Other methods can be used in examples to quantify the data volume of the task into a data volume score of the task D.

Third, the execution time of the task may be quantified to obtain an execution time score of the task.

In a specific example, the execution time can be divided into three levels based on pre-set execution time thresholds: short-term tasks: less than or equal to 30 minutes; regular tasks: greater than 30 minutes but less than or equal to 60 minutes; long term task: more than 60 minutes. Furthermore, the three levels of the execution time mentioned above may be quantified and converted into numerical values in a [0.3, 1.0] interval. It is ensured that the data level with longer execution time dominates in the weighted calculation. These numerical values may refer to execution time scores of the tasks in examples of the present disclosure. Table 3 shows a specific example of a mapping relationship between the execution time levels of the tasks and the execution time scores in the [0.3, 1.0] interval.

TABLE 3

| | Long term | Regular | Short-term |
|---|---|---|---|
| Execution time level | task | tasks | tasks |
| execution time score T | 1 | 0.6 | 0.3 |

It should be noted that the settings and specific quantification method of the execution time of the task illustrated above are only examples. Other methods can be used in examples to quantify the execution time of the task into an execution time score of the task T.

Further, a comprehensive evaluation of the task may be conducted to determine the type of the task it belongs to, based on the priority of the task, the data volume of the task and the execution time of the task.

In some examples, the comprehensive score S of the task can be determined by the following expression:

$$S {=}_{{W}_{d}} \cdot P {+}_{{W}_{d}} \cdot D {+}_{{W}_{t}} \cdot T$$

Among them, wₚ represents a weight of the priority; w_{d} represents a weight of the data volume weight; and wₜ represents a weight of the execution time. For example, they can be set to 0.5, 0.25 and 0.25, respectively. P represents the priority score of the task. D represents the data volume score of the task. T represents the execution time score of the task.

It should be noted that the determination of the comprehensive score and the setting of each weight illustrated above are only examples. Other methods of priority scoring, data volume scoring, and execution time scoring may be adopted to determine the comprehensive score of the task.

Finally, based on a mapping relationship between the comprehensive scores and the types of the tasks, the type of the task can be determined according to the comprehensive score of the task.

In some examples of the present disclosure, the mapping relationship between the comprehensive scores and the types of the task as shown in Table 4 can be pre-set.

TABLE 4

| Comprehensive | |
|---|---|
| score | Type of task |
| 0.8-1 | tasks with high reliabilities and high fault |
| | tolerance requirements |
| 0.6-0.8 | tasks with large-scale parallel computing requirements |
| 0.4-0.6 | tasks with low frequencies, small data volumes |
| | and low real-time requirements |
| 0.2-0.4 | tasks with high real-time requirements |
| 0-0.2 | tasks with hierarchical structures and |
| | centralized resource managements |

Furthermore, in examples of the present disclosure, five kinds of topologies may be provided to support dynamic topology reconfigurations of the ONoC for different types of the tasks. Specifically, the five kinds of topologies may include the torus topology, the mesh topology, the ring topology, the star topology and the tree topology.

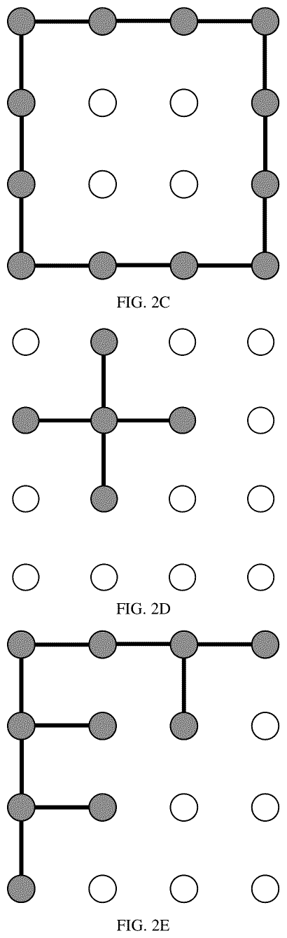

As shown in FIG. 2A, the torus topology may have characteristics such as a high fault tolerance and a relatively short average path length, which can ensure reliable and efficient data transmissions in complex network environments, avoiding data losses and system performance degradations caused by link failures or transmission delays effectively. The torus topology is suitable for performing tasks with high reliability and high fault tolerance requirements. For example, in aerospace vehicles, various sensors and onboard equipment require continuous, stable, and high-speed exchange of data, and any interruption or error in data transmissions can lead to serious consequences. Some links in the torus topology may experience interferences or physical damages. However, in this case, data can still quickly bypass the fault point through redundant paths and reach the destination node accurately, which provide a strong support for the communication network of the aircrafts.

As shown in FIG. 2B, the mesh topology has a many-to-many connectivity with a high bandwidth and a low latency, allowing each node to communicate with other nodes quickly, achieving an efficient data sharing and a collaborative computing. Therefore, the mesh topology is suitable for executing large-scale parallel computing tasks.

As shown in FIG. 2C, the ring topology has a simple structure and fixed data transmission paths, making it suitable for tasks with a small data volume, a relative low transmission frequency, and a low real-time requirement. For example, in an environmental monitoring system, multiple sensors may collect monitoring data (such as a temperature, a humidity, an air quality, and etc.) periodically and transmit the monitoring data to a central node for analysis and processing.

As shown in FIG. 2D, the star topology has low latency characteristics, which can ensure fast transmissions of data between the central node and various endpoints, avoid control errors caused by transmission delays. Therefore, the star topology is suitable for executing tasks with high real-time requirements. For example, in the autonomous vehicle, the data of cameras, radars and other sensors must be transmitted to an on-board computer for processing in real-time, and the computer's control commands also need to be issued to the vehicle quickly, so that the vehicle can control an actuator to execute corresponding actions (such as steering, acceleration, braking, etc.) according to the control commands in time. The star topology structure can guarantee high-speed, real-time data interactions and ensure a driving safety.

As shown in FIG. 2E, the structure of the tree topology is simple. The root node can centrally manage and control the entire network, facilitating the centralized scheduling and management of resources. In the tree topology, the communication path is usually short, and the data transmission efficiency is high, which is suitable for performing tasks with a hierarchical structure and requiring centralized management of resources. For example, in a multi-level image recognition system, the image acquisition device is located at the bottom layer and transmits the collected image data to the image preprocessing nodes of the upper layer for preliminary processing (such as noise reduction, edge detection, etc.), and then transmits the processed data to the feature extraction nodes and classification nodes of the higher layer for final image recognition analysis.

Based on the pre-set topology mentioned above, in some examples of the present disclosure, a correspondence relationship between types of the tasks and topologies can be established in advance, and a target topology suitable for executing a specific task can be selected based on the established correspondence relationship. For example, Table 5 below shows an example of the correspondence relationship between types of the tasks and topologies.

TABLE 5

| Comprehensive | | |
|---|---|---|
| score | Type of task | Topology |
| 0.8-1 | tasks with high reliabilities and | torus topology |
| | fault tolerance requirements | |
| 0.6-0.8 | tasks with large-scale parallel | mesh topology |
| | computing requirements | |
| 0.4-0.6 | tasks with low frequencies, small data | ring topology |
| | volumes and low real-time requirements | |
| 0.2-0.4 | tasks with high real-time requirements | star topology |
| 0-0.2 | tasks with hierarchical structures and | tree topology |
| | centralized resource managements | |

In other examples of the present disclosure, multiple corresponding topologies may be set for each type of the task. For example, for one type of the task, one topology may be set as a preferred topology and at least one topology may be set as an alternative topology. In this way, an alternative topology may be selected in situations where the target nodes and the target links cannot be found based on the preferred topology. Table 6 shows an example of a correspondence between types of the tasks, preferred topologies, and alternative topologies.

TABLE 6

| Comprehensive | | Preferred | Alternative |
|---|---|---|---|
| score | Type of task | Topology | Topology |
| 0.8-1 | tasks with high reliabilities and fault | torus topology | mesh topology |
| | tolerance requirements | | |
| 0.6-0.8 | tasks with large-scale parallel | mesh topology | ring topology |
| | computing requirements | | |
| 0.4-0.6 | tasks with low frequencies, small | ring topology | star topology |
| | data volumes and low real-time | | |
| | requirements | | |
| 0.2-0.4 | tasks with high real-time | star topology | tree topology |
| | requirements | | |
| 0-0.2 | tasks with hierarchical structures and | tree topology | star topology |
| | centralized resource managements | | |

In block 130, target nodes and target links that make up the target topology are determined.

In some examples of the present disclosure, the method of determining the target nodes and the target links that make up the target topology may include the following steps: obtaining status of nodes in the ONoC; obtaining status of links in the ONoC; and determining the target nodes and the target links that make up the target topology based on the target topology, the status of the nodes and the status of the links.

In some examples of the present disclosure, the method of obtaining the status of the nodes in the ONoC may include the following steps: obtaining computing resources, storage resources, and energy consumptions of the nodes; and for each node of the nodes, determining whether the node is in an available status or in an unavailable status based on the computing resources, the storage resources, the energy consumptions of the nodes, and pre-set node availability conditions. It can be seen from this that the status of a node mainly refers to whether the node is available or unavailable. When selecting the target nodes, only available nodes can be considered. Moreover, a priority may be given to available nodes that are close in distance, have more remaining resources, and whose link status meets the requirements of the target topology. That is, nodes that are convenient to be connected and have low loads are prioritized to ensure the quality and the efficiency of the execution of the task.

In some examples of the present disclosure, the method of obtaining status of links in the ONoC may include the following steps: detecting loads and physical connectivity of the links; and for each link of the links, determining whether the link is in an available status or in an unavailable status based on the loads and physical connectivity of the links, and pre-set link availability conditions. It can be seen from this that the status of a link mainly refers to whether the link is available or unavailable. When selecting target links, only available links can be considered.

In some examples of the present disclosure, the method of determining the target nodes and the target links that make up the target topology based on the target topology, the status of the nodes and the status of the links may include the following steps: determining a set of available nodes based on the status of the nodes; determining a topology template corresponding to the target topology; determining a candidate node set from the available nodes based on the topology template; and determining the target nodes and the target links from the candidate node set based on the status of the links.

In examples of the present disclosure, the step of determining a set of available nodes based on the status of the nodes may include: obtaining information on computing resources, storage resources, and energy consumptions of the nodes; selecting nodes with basic working capabilities to form a set of available nodes and based on preset node availability conditions. The preset node availability conditions may include a computing resource threshold, a storage resource threshold or an energy consumption limit. This step may only focus on the status of the nodes themselves and may not be related to the topology structure.

In examples of the present disclosure, the target template may be a structured data model corresponding to the target topology, which formally includes topology features, node position constraints and/or reserved redundant node positions. For example, the topology features may include an N×M grid coordinate range corresponding to the torus topology, or a circular path coordinate sequence corresponding to the ring topology, and etc. The node position constraints may include a Manhattan distance or coordinate continuity requirements between nodes. Moreover, the redundant node reserved positions may include alternative node coordinates.

Subsequently, in examples of the present disclosure, the step of determining a candidate node set from the available nodes based on the topology template may include: at first, filtering nodes in the set of the available nodes to find nodes that meet the topology features and the node position constraints to form a candidate node set. In response to determining that the topology template includes the reserved redundant node positions, the nodes that match the reserved redundant node positions in the candidate node set will be comprehensively scored and sorted based on remaining computing resources and storage capacities to determine priorities of the redundant nodes for replacement in case of subsequent link failures.

Further, the step of determining a candidate node set from the available nodes based on the topology template may further include: determining the target links based on the status of the links. In this step, links that should be formed are firstly determined according to the topology features of the topology template in the candidate node set as candidate target links. Then, the load and physical connectivity status information of each candidate target link is check to determine whether the candidate target link is available based on the preset link availability conditions. Further, for unavailable links, according to previously determined ranking of redundant nodes, replace the corresponding node connected to the unavailable link with the resource suboptimal redundant node, and re-check the status of the replaced link. Repeat this process until all the target nodes and the target links are determined. If there are still unavailable links after attempting to replace all redundant nodes, it indicates that the current target topology cannot be constructed, and an alternative topology needs to be selected based on the type of the task, and the selection process of the target nodes and the target links needs to be redone.

The methods for selecting the target nodes and the target links for different topologies can be briefly summarized in Table 7.

TABLE 7

| Topology | Target nodes | Target links |
|---|---|---|
| torus | filtering nodes within an N × M grid; and | closing horizontal and vertical |
| topology | selecting target nodes based on coordinate | links and reserving redundant |
| | continuity | paths |
| mesh | filtering nodes within an M × M grid; and | filtering fully connected links |
| topology | selecting M² top nodes according to a | and performing a load |
| | resource rating | balancing processing |
| ring | filtering peripheral nodes of the matrix; | connecting nodes in order, and |
| topology | sorting the nodes clockwise; and selecting | replacing corresponding nodes |
| | K top nodes according to a resource rating | if the link is unavailable to |
| | | ensure a closed loop |
| star | determining a central node; filtering leaf | connecting the center node and |
| topology | nodes within a one-hop range; and | the leaf nodes; and prohibiting |
| | selecting K top nodes according to a | inter leaf links |
| | resource rating | |
| tree | filtering a root node, child nodes and leaf | unidirectional conducting |
| topology | nodes according to a hierarchical structure; | parent-child links |
| | and performing resource matching of | |
| | nodes at each level | |

In some examples of the present disclosure, the method may further include: in response to determining that the target nodes that make up the target topology cannot be determined, selecting an alternative topology based on the type of the task; and determine the target nodes and the target links that make up the alternative topology based on the alternative topology and the status of the nodes.

In some examples of the present disclosure, when selecting the target nodes that make up the target topology, if it fails to select the target nodes that makes up the target topology, it is necessary to re-select another alternative topology suitable for executing the task. Then the target nodes that make up the alternative topology may be selected from all nodes. Moreover, the target links between the target nodes may be connected according to the alternative topology. That is, if the target topology cannot be formed due to insufficient resources or inconsistent positions of some nodes, it is necessary to re-determine a topology for executing the task and select corresponding target nodes.

In some examples, one or more alternative topologies may be provided for each type of the task in cases where the target topology cannot be formed. For example, as shown in the example in Table 6, the alternative topology for tasks with high reliabilities and high fault tolerance requirements may be the mesh topology; the alternative topology for tasks with large-scale parallel computing requirements may be the ring topology; the alternative topology for tasks with low frequencies, small data volumes and low real-time requirements may be the star topology; the alternative topology for tasks with high real-time requirements may be the tree topology; and the alternative topology for tasks with hierarchical structures and centralized resource managements may be the star topology. That is, when the target topology of a certain type of the task cannot be formed, an alternative topology for that type of the task may be selected, and the target nodes and the target links may be re-selected according to the alternative topology to complete the task using the alternative topology. Optionally, when the target topology and alternative topology of the task cannot be successfully formed, other suitable topology can still be selected, and when there are multiple selectable topologies, a relatively simple topology is preferred.

In some examples, due to the fact that the torus topology can not only ensure the progress of high priority tasks, but also switch to other topologies quickly and flexibly, the ONoC may adopt a pre-configured torus topology structure as the basic topology structure. That is, before a new task arrives, the topology of the ONoC is initialized to the torus topology. When a new task arrives, the torus topology may be switched to the target topology, thereby achieving efficient resource reuse and improving the overall processing efficiency and task completion of the system. It should be noted that in general, initialization operations are only required when the previous network topology is not the torus topology.

Specifically, in some examples, an initialization process of the torus topology may include the following three processes: a pre-configuration of a hardware infrastructure, an initialization of resource status, and an initialization of a control signaling layer.

The pre-configuration of the hardware infrastructure may include: a physical layer pre-configuration and a micro-ring resonator state configuration. Among them, the physical layer pre-configuration may include pre-deploying all horizontal and vertical links according to the torus topology to form closed loops. The micro-ring resonator state configuration may include presetting all the micro-ring resonators corresponding to each link to the active state, retaining only the basic temperature compensation circuit, and controlling a power consumption at 0.1 mW/node.

The initialization of resource status may include: a node resource releasing and a link state tagging. Among them, the node resources releasing may include releasing caches and computing units of inactive nodes, and incorporating the released caches and computing units into a buffer. The link status tagging may include marking all torus links as non-conductive, and keeping the physical layer activatable.

The initialization of the control signaling layer may include a priority queue presetting and a global routing table initialization. Among them, the priority queue presetting may include emptying a priority queue and waiting for a task to trigger. The global routing table initialization may include generating a default routing table for the torus topology, which contains the physical location information of all nodes, but does not activate an actual forwarding function.

In some examples of the present disclosure, switching the torus topology to the target topology may include: after determining the target nodes and the target links, conducting the target link and the target nodes by setting an on/off (μs level) state of the micro-ring resonators to achieve a fast switching to the target topology.

In some examples of the present disclosure, the method may further include: after determining the target nodes and the target links that make up the target topology, sending an activating signal to the target nodes, and sending an inactivating signal to nodes that do not make up the target topology; and sending a conducting signal to the target links.

In some examples, after determining the target topology and selecting the target nodes and the target links that make up the target topology, the control unit may send activating signals to the selected target nodes and inactive signals to nodes that do not make up the target topology. The node receiving the activating signal may set its state to active, perform initialization operations, and enter a normal working state. The node receiving the inactive signal may set its state to inactive, release the resources it occupies. At the same time, the control unit may send a conduction signal to the target links. After receiving the conduction signal, the optical router may turn on or turn off the micro-ring resonator to adjust a state of a corresponding optical link to ensure that the optical signal can be transmitted on the selected path. And controlling of the links may be implemented through the control signaling layer to ensure the accuracy of signal transmission.

For example, using the torus topology as the initialization topology, closed loops may be formed by pre-configuring all horizontal and vertical links to ensure transmission paths between the nodes. For the mesh topology, multiple horizontal and vertical links are enabled to ensure a many to many data transmission relationship between the nodes. For the ring topology structure, only the links on the ring path are conductive and other redundant links are closed to reduce power consumptions. For a star topology, direct connection links between the central node and each endpoint may be established to ensure low latency transmissions of data between the central node and the endpoints. For the tree topology, one-way links from the root node to the leaf nodes are conducted hierarchically, and non-hierarchical links are closed to achieve a centralized resource scheduling and management. The process of link conduction may be scheduled through the control signaling layer, and the activations of the micro-ring resonators may be triggered by the control signal to ensure unobstructed transmission of optical signals on the selected path. In some ways, to cope with the transient impact and optical signal reflection problems during link conductions, a brief delay mechanism can be used to improve the smoothness of link switching and the continuity of data transmission.

In some ways, a routing table isolation may be achieved through dynamic generation and incremental updates to ensure that data is only transmitted on effective paths formed by active nodes and conductive links, eliminating invalid nodes and links. Micro-ring resonators are precisely controlled at the physical layer to block ineffective links, prevent signal leakage, and ensure the reliability of optical transmission.

In some examples of the present disclosure, the method may further include: after sending a conducting signal to the target links, sending a detecting signal to the target nodes; in response to determining that no feedback signal is received from the target nodes or a transmission quality is evaluated to be lower than a preset quality threshold based on a feedback signal, optimizing status of the target links by adjusting the parameters of micro-ring resonators.

In some examples, after all nodes have been activated and all links have completed conduction, a specific wavelength optical signal may be sent from the optical router along the planned link to the control unit for feedback that the target topology structure has been established. After establishing the target topology structure, the control unit sends a detection signal to the target topology structure to test whether the links of the target topology structure are normal, and detects the transmission quality of the target topology structure through statistical error rate and other methods. If no feedback signal is received from the target topology structure or the transmission quality does not reach the quality threshold, it indicates that the quality of the established target topology structure is not high. The link state is optimized by adjusting the micro-ring resonator parameters.

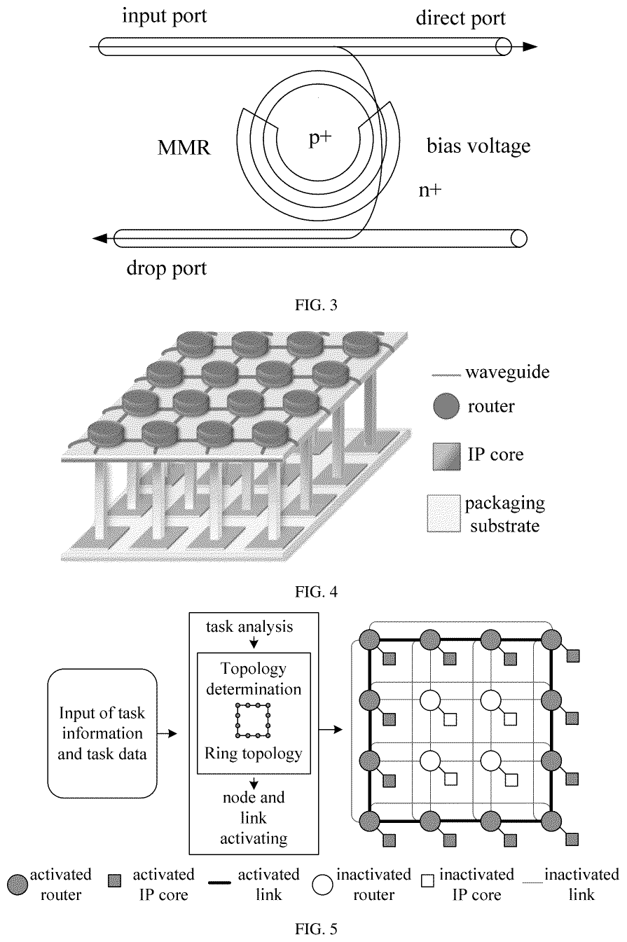

In some ways, the method of adjusting the micro-ring resonator parameters to optimize the link state can be to adjust the size of the bias voltage to adjust the split ratio (the initial value is 1), and then adjust the amount of data to the target node. As shown in FIG. 3, when an appropriate bias voltage is applied to the PIN diode, the micro-ring resonator operates in a transient state, guiding the alpha portion of light to the descending port while forwarding the remaining (1−α) portion of light to the through port. At this point, the splitting ratio is α/(1−α). By adjusting the bias voltage within the range of [0,5V], different splitting ratios within the range of [0.4, 1.8] can be obtained. Optionally, the bias voltage can be adjusted through a digital to analog converter. If a splitting ratio exceeding the range of [0.4, 1.8] is required, multiple micro-ring resonators can be cascaded to obtain it.

After adjustment, if the feedback signal cannot be received or the transmission quality does not meet the quality threshold, the node reselection process will be triggered and the link configuration will be reconstructed based on the reselected nodes, that is, the nodes and links will be reelected to reconstruct the topology that meets the quality requirements.

As shown in FIG. 4, in some examples, the ONoC may include a control signaling layer, an optical network layer, and a multi-core processor. Among them, the control signaling layer includes routers and telecommunication channels, the optical network layer includes optical routers and transmission waveguides, the 16 core processor is connected in a 4×4 grid network, and each node may include an IP core and a router. A two-dimensional coordinate system may be established by taking the horizontal direction as an X-axis direction and taking the vertical direction as a Y-axis direction. Further, a coordinate position of each node in the coordinate system may be determined. For example, the coordinate of the lower left corner node is (0,0), the coordinate of the upper left corner node is (0,3), the coordinate of the lower right corner node is (3,0), and the coordinate of the upper right corner node is (3,3).

As shown in FIG. 5, when the ONoC receives task information, it parses and evaluates the task information, determines the type of the task, and determines the suitable target topology based on the type of the task. If the target topology is a circular topology, further select nodes that can form a ring topology based on the resource status of all nodes, such as nodes with coordinates of (0,0), (0,1), (0,2), (0,3), (1,3), (2,3), (3,3), (3,2), (3,1), (3,0), (2,0), and (1,0). Set the status of these nodes to active as the target nodes that make up the ring topology, set the status of other nodes to inactive, and connect the links between the target nodes to construct the ring topology.

In block 130, a global routing table based on the target nodes and the target links is generated.

In some examples of the present disclosure, the process of generating a global routing table may include a path calculation, a routing algorithm selection, and constructions of routing table entries.

Among them, the path calculation and routing algorithm selection may adopt a shortest path priority and a load balancing strategy. The shortest path priority may include calculating a shortest hop path between any two nodes based on node connection relationships of the target topology. The load balancing strategy may include allocating traffic based on link loads to avoid congestions when there are multiple equivalent paths.

The constructions of routing table entries may include: setting node coordinates, information of a source node, a destination node, next hop nodes, and status of the links.

It should be noted that during a topology adjustment, an incremental update may be adopted to update related routing table entries.

In block 140, the global routing table may be issued to the target nodes enable the ONoC to forward task data according to the global routing table.

In some examples of the present disclosure, after determining the target topology and selecting the target nodes and the target links that make up the target topology, a global routing table may be generated based on the selected target nodes and the target links, and the global routing table may be distributed to each target node, so that each target node may forward and process task data according to the global routing table. Due to the fact that in practical applications, each node may have a corresponding buffer to store the global routing table, once the target topology is determined, it is only necessary to issue and update the global routing table of the corresponding node (usually the target node) in the target topology. After the global routing table is issued, the topology reconstruction process of the ONoC is completed.

In some ways, error detection and retransmission mechanisms may be used to ensure accurate transmissions of the global routing table to each node when distributing it. The routing information of the global routing table is generated based on the selected nodes and links according to a preset routing algorithm. To reduce the delay caused by routing table updates, an incremental routing update strategy is adopted, which only updates routing information, improves the efficiency of the global routing table updates, and ensures the efficiency and stability of data transmissions after a topology switching.

The topology reconfiguration method for an ONoC provided in examples of the present disclosure involves parsing task information of a task and evaluating resources to determine a type of the task, selecting an appropriate target topology, selecting nodes and links according to the target topology, activating nodes and conducting links, constructing a global routing table for the selected nodes and links, and issuing the global routing table. The network executes tasks according to the target topology. Based on the task driven reconfiguration of topology, it can adapt to diverse task requirements, improve flexibility and adaptability, and fully unleash system performance and potential. By pre-configuring the topology of on-chip links and nodes, it is ensured that they can switch to the target topology quickly when a task arrives suddenly, which can improve the overall processing efficiency and task completion of the system. In addition, the method of this application may be used for network layer resource allocations and will not bring additional internal interference factors to subsequent transmissions, making it highly adaptable.

It should be noted that the method of the present disclosure can be executed by a single device, such as a computer or server. The method of the present disclosure can also be applied to distributed scenarios, where multiple devices cooperate with each other to complete the task. In this distributed scenario, one device among these multiple devices can only perform one or more steps of the method described in the embodiments of the present application, and these multiple devices will interact with each other to complete the method.

It should be noted that specific examples of this manual have been described above. Other examples are within the scope of the appended claims. In some cases, the actions or steps described in the claims may be performed in a different order than in the examples and still achieve the desired results. In addition, the process depicted in the figures does not necessarily require a specific or continuous order to achieve the desired results. In some implementations, multitasking and parallel processing are also possible or may be advantageous.

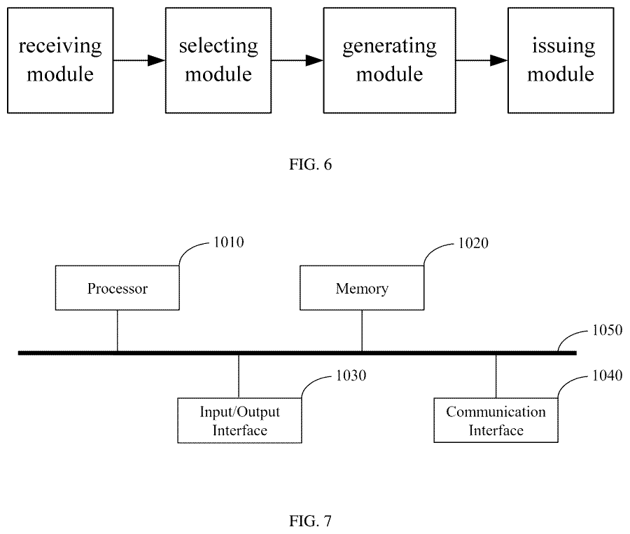

FIG. 6 shows a specific structure of the topology reconfiguration device according to examples of the present disclosure. As shown in FIG. 6, the topology reconfiguration device may include the following modules.

A receiving module, configured to receive task information.

A selecting module, configured to select a target topology based on the task information and determine target nodes and target links that make up the target topology.

A generating module, configured to generate a global routing table based on the target nodes and the target links.

An issuing module, configured to issue the global routing table to the target nodes to enable the ONoC to forward task data according to the global routing table.

It should be noted that implementations and specific technical effects of each module in the device can refer to implementation of steps in previous examples, and will not be repeated here.

Based on a same inventive concept and corresponding to examples of the present disclosure, the present disclosure also provides an electronic device comprising: a memory, a processor, and a computer program stored on the memory and executable on the processor. When the processor executes the computer program, it implements the topology reconfiguration method for an ONoC.

FIG. 7 illustrates a more detailed hardware structure diagram of an electronic device according to this example. The device may include: a processor 1010, a memory 1020, an input/output interface 1030, a communication interface 1040, and a bus 1050. The processor 1010, memory 1020, input/output interface 1030, and communication interface 1040 are communicatively connected within the device via the bus 1050.

The processor 1010 may be implemented using a general-purpose CPU (Central Processing Unit), microprocessor, ASIC (Application-Specific Integrated Circuit), or one or more integrated circuits. It is configured to execute related programs to implement the technical solutions provided in the examples of the present specification.

The memory 1020 may be implemented using ROM (Read-Only Memory), RAM (Random Access Memory), static storage devices, or dynamic storage devices. The memory 1020 stores operating systems and other applications. When implementing the technical solutions of the examples of the present specification via software or firmware, related program codes are stored in the memory 1020 and invoked by the processor 1010 for execution.

The input/output interface 1030 is connected to an input/output module to enable information input and output. The input/output module may be integrated into the device (not shown) or externally connected to provide corresponding functions. Input devices may include keyboards, mice, touchscreens, microphones, and various sensors. Output devices may include displays, speakers, vibrators, and indicator lights.

The communication interface 1040 is connected to a communication module (not shown) to enable communication between the device and other devices. The communication module may use wired methods (e.g., USB, network cables) or wireless methods (e.g., mobile networks, Wi-Fi, Bluetooth).

The bus 1050 provides a pathway for transmitting information among components (e.g., processor 1010, memory 1020, input/output interface 1030, and communication interface 1040) of the device.

It should be noted that although the above device illustrates only the processor 1010, memory 1020, input/output interface 1030, communication interface 1040, and bus 1050, additional components necessary for normal operation may be included in practical implementations. Furthermore, those skilled in the art will understand that the device may include only components necessary for implementing the solutions of the examples of the present specification and need not include all components shown in the figure.

The electronic device in the above examples is used to implement the topology reconfiguration method for an ONoC in any of the preceding examples and has the beneficial effects of the corresponding method, which are not repeated here.

Based on the same inventive concept and corresponding to any of the above method, the present disclosure further provides a non-transitory computer-readable storage medium storing computer instructions. The computer instructions are configured to cause a computer to execute the topology reconfiguration method for an ONoC as described in any of the preceding examples.

The computer-readable medium in this example includes permanent and non-permanent, removable and non-removable media implemented by any method or technology for information storage. The information may be computer-readable instructions, data structures, program modules, or other data. Examples of computer storage media include, but are not limited to: phase-change memory (PRAM), static random-access memory (SRAM), dynamic random-access memory (DRAM), other types of RAM, read-only memory (ROM), electrically erasable programmable read-only memory (EEPROM), flash memory, other memory technologies, CD-ROM, DVD, other optical storage, magnetic cassettes, magnetic tape storage, other magnetic storage devices, or any other non-transitory media capable of storing information accessible to computing devices.

The storage medium in the above examples stores computer instructions for causing a computer to execute the topology reconfiguration method for an ONoC as described in any of the preceding examples, with the beneficial effects of the corresponding method, which are not repeated here.

Those skilled in the art should understand that the discussion of the above examples is exemplary and not intended to imply that the scope of the present disclosure (including the claims) is limited to these examples. Under the principles of the present disclosure, the technical features in the above examples or different examples may be combined, steps may be executed in any order, and many other variations exist as described in the different aspects of the examples of the present disclosure, which are not detailed for brevity.

Additionally, to simplify explanation and discussion and to avoid obscuring the examples of the present disclosure, known power/ground connections to integrated circuit (IC) chips and other components may or may not be shown in the provided figures. Furthermore, devices may be illustrated in block diagram form to avoid obscuring the examples, considering that implementation details of such block diagrams are highly platform-dependent (i.e., these details should be fully understandable to those skilled in the art). When specific details (e.g., circuits) are provided to describe exemplary examples of the present disclosure, it will be apparent to those skilled in the art that the examples may be practiced without these details or with modifications thereto. Thus, the descriptions are to be regarded as illustrative rather than restrictive.

Although the present disclosure has been described with reference to specific examples, many alternatives, modifications, and variations will be apparent to those skilled in the art based on the foregoing description. For example, other memory architectures (e.g., dynamic RAM (DRAM)) may be used in the discussed examples.

The examples of the present disclosure are intended to cover all such alternatives, modifications, and variations falling within the broad scope of the appended claims. Therefore, any omissions, modifications, equivalent substitutions, or improvements made within the spirit and principles of the examples of the present disclosure shall be included within the scope of protection of the present disclosure.

What is claimed is:

1. A topology reconfiguration method for an Optical Network-on-Chip (ONoC), comprising:
receiving task information;
selecting a target topology based on the task information;
determining target nodes and target links that make up the target topology;
generating a global routing table based on the target nodes and the target links; and
issuing the global routing table to the target nodes to enable the ONoC to forward task data according to the global routing table.

2. The method according to claim 1, wherein, the task information comprises: a priority of a task, a data volume of the task, and an execution time of the task.

3. The method according to claim 2, wherein, the selecting a target topology based on the task information comprises:
determining a type of the task corresponding to the task information based on the priority of the task, the data volume of the task, and the execution time of the task; and
selecting the target topology based on the type of the task.

4. The method according to claim 3, wherein, the determining a type of the task corresponding to the task information based on the priority of the task, the data volume of the task, and the execution time of the task comprises:
quantifying the priority of the task to obtain a priority score;
quantifying the data volume of the task to obtain a data volume score;
quantifying the execution time of the task to obtain an execution time score;
determining a comprehensive score of the task based on the priority score, the data volume score, and the execution time score; and
determining the type of the task based on the comprehensive score according to a mapping relationship between comprehensive scores and types of the tasks.

5. The method according to claim 1, wherein, the determining target nodes and target links that make up the target topology comprises:
obtaining status of nodes in the ONoC;
obtaining status of links in the ONoC; and
determining the target nodes and the target links that make up the target topology based on the target topology, the status of the nodes and the status of the links.

6. The method according to claim 5, wherein, the obtaining status of nodes in the ONoC comprises:
obtaining computing resources, storage resources, and energy consumptions of the nodes; and
for each node of the nodes, determining whether the node is in an available status or in an unavailable status based on the computing resources, the storage resources, the energy consumptions of the nodes, and pre-set node availability conditions;
the obtaining status of links in the ONoC comprises:
detecting loads and physical connectivity of the links; and
for each link of the links, determining whether the link is in an available status or in an unavailable status based on the loads and physical connectivity of the links, and pre-set link availability conditions.

7. The method according to claim 5, wherein, the determining the target nodes and the target links that make up the target topology based on the target topology, the status of the nodes and the status of the links comprises:
determining a set of available nodes based on the status of the nodes;
determining a topology template corresponding to the target topology;
determining a candidate node set from the available nodes based on the topology template; and
determining the target nodes and the target links from the candidate node set based on the status of the links.

8. The method according to claim 7, wherein, the determining a set of available nodes based on the status of the nodes comprises:
obtaining information on at least one of computing resources, storage resources, and energy consumptions of the nodes as status information of the nodes;
selecting nodes with basic working capabilities based on the status information of the nodes and preset node availability conditions to form a set of available nodes; wherein, the preset node availability conditions comprise at least one of a computing resource threshold, a storage resource threshold and an energy consumption limit.

9. The method according to claim 8, wherein, the target template comprises topology features and node position constraints; and
the determining a candidate node set from the available nodes based on the topology template comprises:
filtering each node in the set of the available nodes to find nodes that meet the topology features and the node position constraints to form a candidate node set.

10. The method according to claim 9, wherein, the determining the target nodes and the target links from the candidate node set based on the status of the links comprises:
taking the nodes in the candidate node set as the target nodes;
determining links that should be formed according to the topology features of the topology template in the candidate node set as candidate target links;
checking the status of the candidate target links; and
for each candidate target link, in response to determining that the candidate target link is in an available status, taking the candidate target link as the target link.

11. The method according to claim 10, the target template further comprises reserved redundant node positions;
the determining a candidate node set from the available nodes based on the topology template further comprises:
scoring and sorting nodes that match the reserved redundant node positions in the candidate node set based on the status information of the nodes that match the reserved redundant node positions; and
the determining the target nodes and the target links from the candidate node set based on the status of the links further comprises:
in response to determining that the candidate target link is in an unavailable status, replacing the target nodes connecting the target link with suboptimal redundant nodes, and return to the step of checking the status of the candidate target links until it is determined that all target links are available.

12. The method according to claim 5, further comprising:
after determining the target nodes and the target links that make up the target topology based on the target topology, the status of the nodes and the status of the links, in response to determining that the target nodes or the target links that make up the target topology cannot be selected,
selecting an alternative topology based on the type of the task; and
determine the target nodes and the target links that make up the alternative topology based on the alternative topology and the status of the nodes.

13. The method according to claim 1, further comprising:
after determining the target nodes and the target links that make up the target topology, sending an activating signal to the target nodes;
sending an inactivating signal to nodes that do not make up the target topology; and
sending a conducting signal to the target links.

14. The method according to claim 13, further comprising:
after sending a conducting signal to the target links, sending a detecting signal to the target nodes; and
in response to determining that no feedback signal is received from the target nodes or a transmission quality is evaluated to be lower than a preset quality threshold based on a feedback signal, optimizing status of the target links by adjusting the parameters of micro-ring resonators.

15. The method according to claim 1, further comprising:
before selecting the target topology based on the task information, initializing a network topology of the ONoC to the torus topology; and
after selecting the target topology based on the task information, switching the torus topology to the target topology.

16. An electronic device, comprising:
a memory, a processor, and a computer program stored on the memory and executable by the processor, wherein the processor executes the computer program to implement the method according to claim 1.

17. A non-transitory computer-readable storage medium, storing computer instructions, wherein the computer instructions are used to cause a computer to execute the method according to claim 1.
